(19) United States
(12) Patent Application Publication
(10) Pub. No.: US 2025/0164852 A1
(43) Pub. Date: May 22, 2025

(54) FREQUENCY CONVERSION CAVITY FOR TUNABLE CONTINUOUS WAVE UV LASERS

(71) Applicant: BOARD OF TRUSTEES OF THE UNIVERSITY OF ARKANSA, Little Roack, AR (US)

(72) Inventors: Ethan Favorite, Fayetteville, AR (US); Hiroyuki Nakamura, Fayetteville, AR (US)

(73) Assignee: BOARD OF TRUSTEES OF THE UNIVERSITY OF ARKANSAS, Little Rock, AR (US)

(21) Appl. No.: 18/840,474

(22) PCT Filed: Feb. 20, 2023
(86) PCT No.: PCT/US2023/013427

§ 371 Date: Aug. 21, 2024

Related U.S. Application Data
(60) Provisional application No. 63/312,766, filed on Feb. 22, 2022.

(51) Int. Cl. G02F 1/35; H01S 3/00; H01S 3/23

(52) U.S. Cl. CPC G02F 1/3534; H01S 3/0092; H01S 3/2391

(57) ABSTRACT

Embodiments of the present disclosure pertain to a module that includes an optically non-linear material operable to receive at least a first laser beam and a second laser beam and perform sum frequency mixing of the first and second laser beams to generate another laser beam. The module also includes a first mirror and a second mirror. The first mirror includes a first aperture operable for passing at least one of the first or second laser beams through the first mirror and into the module. The second mirror includes a second aperture operable for passing the generated laser beam through the second mirror and out of the module. Additional embodiments pertain to laser generation systems that include the modules. Further embodiments pertain to methods of generating a laser beam by utilizing the modules and laser generation systems of the present disclosure.

### CROSS-REFERENCE TO RELATED APPLICATIONS

This application claims priority to U.S. Provisional Patent Application No. 63/312,766, filed on Feb. 22, 2022. The entirety of the aforementioned application is incorporated herein by reference.

### BACKGROUND

Current laser systems (e.g., laser systems working at ultraviolet and shorter wavelengths) have numerous limitations, such as the unavailability of desired wavelengths, the lack of tunability, and limited lifetime. Various embodiments of the present disclosure seek to address the aforementioned limitations.

### SUMMARY

In some embodiments, the present disclosure pertains to a module. In some embodiments, the module includes an optically non-linear material operable to receive at least a first laser beam and a second laser beam and perform sum frequency mixing of the first and second laser beams to generate another laser beam. The module also includes a first mirror and a second mirror. The first mirror includes a first aperture operable for passing at least one of the first or second laser beams through the first mirror and into the module. The second mirror includes a second aperture operable for passing the generated laser beam through the second mirror and out of the module.

In some embodiments, the modules of the present disclosure may be associated with a laser generation system. Additional embodiments of the present disclosure pertain to laser generation systems that include the modules of the present disclosure.

Further embodiments of the present disclosure pertain to methods of generating a laser beam by passing a first laser beam and a second laser beam into a module of the present disclosure. Thereafter, at least one of the first or second laser beams passes through the first aperture of the first mirror and into the module. Next, an optically non-linear material of the module performs sum frequency mixing of the two laser beams to generate the laser beam (e.g., ultraviolet (UV) or deep ultraviolet (DUV) laser beams). The generated laser beam then exits out of the module through the second aperture of the second mirror.

### BRIEF DESCRIPTION OF THE DRAWINGS

FIG. 1 illustrates a module in accordance with numerous embodiments of the present disclosure.

FIGS. 2A-2C provide illustrations of an exemplary mirror for use in the modules of the present disclosure, including a top view (FIG. 2A), a projected view (FIG. 2B), and a side view (FIG. 2C).

FIGS. 3A-3D provide illustrations of an exemplary detachable plate for supporting the modules of the present disclosure, including a top view (FIG. 3A), a side view (FIG. 3B), a bottom view (FIG. 3C), and a projected view (FIG. 3D).

FIG. 4 provides an illustration of a vacuum system suitable for use in fabricating the modules of the present disclosure.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

There is an increasing demand for narrow-bandwidth continuous wave (cw) lasers that emit strong UV light, especially in the fields of materials research, semiconductor inspection, semiconductor lithography, and quantum technologies associated with the control of atoms using laser. One of the leading technologies to investigate materials is the use of photoelectrons, an electron that is ejected from a material by UV light with short wavelengths (e.g., below around 200 nm). This photoelectron spectroscopy has traditionally used noble gas lamps such as Helium lamps. However, more recently, lasers are being utilized due to advances in laser technology.

Many commercially available lasers are limited in the selection of wavelength, typically offering output only at a single wavelength, such as 193 nm, 205 nm or 112 nm. Moreover, many commercially available lasers operate in a pulsed mode with a low repetition frequency (such as 1 kHz), which is not suitable for photoelectron spectroscopy. For example, industrially available excimer laser, operating at 193 nm, is a pulsed laser with a broad spectrum.

Another forefront in the use of cw UV lasers is advanced quantum technology, such as trapping and cooling of atoms for ultra-precise atomic clocks and ion-based quantum computing. In these quantum applications, a cw laser with narrow linewidth (typically less than 1 MHz) is required to perfectly tune the laser wavelength with respect to an atomic transition of a target atom or ion. However, such laser beams are not readily available for deep UV wavelengths.

Moreover, there are very few available commercial laser systems that output laser beams below 200 nm. This is due to various difficulties, including materials and optics limitations for such short wavelengths. However, a major limitation is the degradation of components under the radiation of ultraviolet and shorter wavelengths.

Accordingly, a need exists for cw lasers with tunable wavelengths and a long lifetime at deep UV regions. Such cw lasers hold great promise for numerous applications, such as accelerating materials research, semiconductor inspection or processing, and quantum technologies. Numerous embodiments of the present disclosure address the aforementioned need.

### Modules

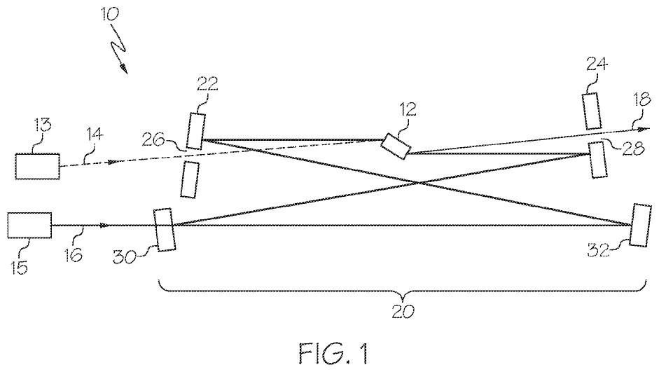

In some embodiments, the present disclosure pertains to modules. In some embodiments, the modules are structurally operable to generate a laser beam. In some embodiments, the modules of the present disclosure are illustrated as module 10 in FIG. 1. With reference to FIG. 1 for illustrative purposes only, module 10 includes optically non-linear material 12, which is operable to receive at least a first laser beam 14 from a laser source 13, and a second laser beam 16 from a laser source 15. Optically non-linear material 12 is also operable to perform sum frequency mixing of the first and second laser beams to generate laser beam 18.

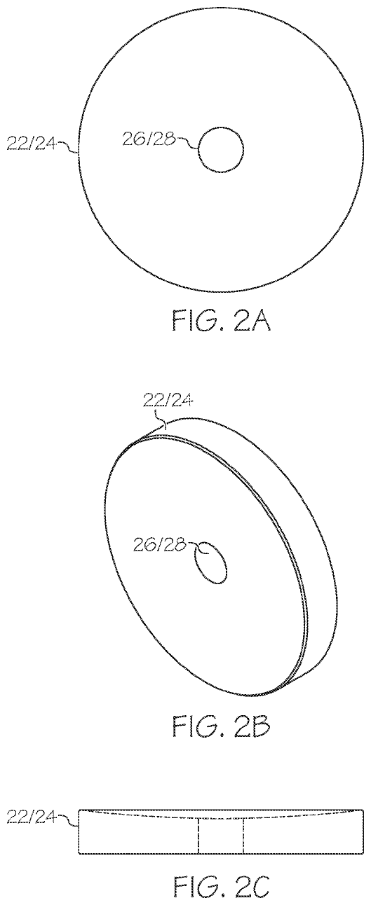

Module 10 also includes cavity 20 for housing optically non-linear material 12. Module 10 also includes a first mirror 22, a second mirror 24, a third mirror 30, and a fourth mirror 32. First mirror 22 includes a first aperture 26 operable for passing at least one of the first or second laser beams through the first mirror 22 and into module 10. Second mirror 24 includes a second aperture 28 operable for passing the generated laser beam 18 through the second mirror 24 and out of module 10. FIGS. 2A-2C provide more detailed depictions of first mirror 22, second mirror 24, first aperture 26, and second aperture 28. As set forth in more detail herein, the modules of the present disclosure can have numerous embodiments.

The modules of the present disclosure may utilize various types of laser beams. For instance, in some embodiments, the first and second laser beams include different wavelengths. In some embodiments, the first and second laser beams include IR lasers.

In some embodiments, the first laser beam includes a wavelength of at least 200 nm. In some embodiments, the first laser beam includes a wavelength of 244 nm. In some embodiments, the first laser beam includes a wavelength of 266 nm. In some embodiments, the first laser beam includes a wavelength of at least 500 nm. In some embodiments, the first laser beam includes a wavelength of 532 nm. In some embodiments, the first laser beam includes deep UV wavelengths. In some embodiments, the first laser beam includes IR wavelengths.

In some embodiments, the second laser beam includes an IR laser. In some embodiments, the second laser beam includes a wavelength of at least 500 nm. In some embodiments, the second laser beam includes a wavelength of at least 600 nm. In some embodiments, the second laser beam includes a wavelength ranging from 690 nm to 850 nm. In some embodiments, the second laser beam includes a wavelength ranging from 850 nm to 2000 nm. In some embodiments, the second laser beam has a wavelength that is larger than the first laser beam.

The modules of the present disclosure may also utilize various types of mirrors at various positions within the module. For instance, in some embodiments, the first mirror and the second mirror are on opposite sides of the module. In some embodiments, the first mirror and the second mirror are detachable. In some embodiments, the first mirror and second mirror are adjustable. In some embodiments, the modules of the present disclosure can also utilize additional mirrors, such as third mirror 30 and fourth mirror 32 illustrated in FIG. 1.

In some embodiments, the mirrors of the present disclosure are arranged in a manner to maximize the sum frequency mixing of the first and second laser beams by the optically non-linear materials of the present disclosure. For instance, in some embodiments illustrated in FIG. 1, mirrors 22, 24, 30 and 32 are arranged such that they maximize the reflection and/or transmission of the first and second laser beams onto an optically non-linear material for sum frequency mixing.

The mirrors of the present disclosure can also include various types of apertures. For instance, in some embodiments illustrated in FIGS. 2A-2C, the apertures include at least one of holes, slits, openings, or combinations thereof. In some embodiments, the apertures do not block the passage of the input or output laser beams.

In some embodiments, the apertures of the present disclosure are in the form of a continuous opening through a mirror. For instance, in some embodiments, the first aperture of the first mirror is in the form of a continuous opening through the first mirror. In some embodiments, the second aperture of the second mirror is in the form of a continuous opening through the second mirror.

The modules of the present disclosure may include various types of optically non-linear materials. For instance, in some embodiments, the optically non-linear materials of the present disclosure include a non-linear crystal. In some embodiments, the crystals include beta-barium borate (BBO), Cesium lithium borate (CLBO), or Lithium borate (LBO) crystals.

In some embodiments, the optically non-linear materials of the present disclosure include an optical fiber. In some embodiments, the optical fiber may be a hollow core fiber that acts as a nonlinear media allowing sum frequency mixing.

The modules of the present disclosure may generate various types of laser beams. For instance, in some embodiments, the generated laser beam includes a monochromatic laser with a single wavelength. In some embodiments, the generated laser beam includes a wavelength ranging from 180 nm to 250 nm. In some embodiments, the generated laser beam includes a wavelength ranging from 184 nm to 218 nm. In some embodiments, the generated laser beam includes a wavelength ranging from 206 nm to 235 nm. In some embodiments, the generated laser beam includes a wavelength ranging from 206 nm to 235 nm. In some embodiments, the generated laser beam includes a wavelength ranging from 190 nm to 235 nm. In some embodiments, the generated laser beam includes an ultraviolet (UV) laser beam. In some embodiments, the generated laser beam includes a deep ultraviolet (DUV) laser beam.

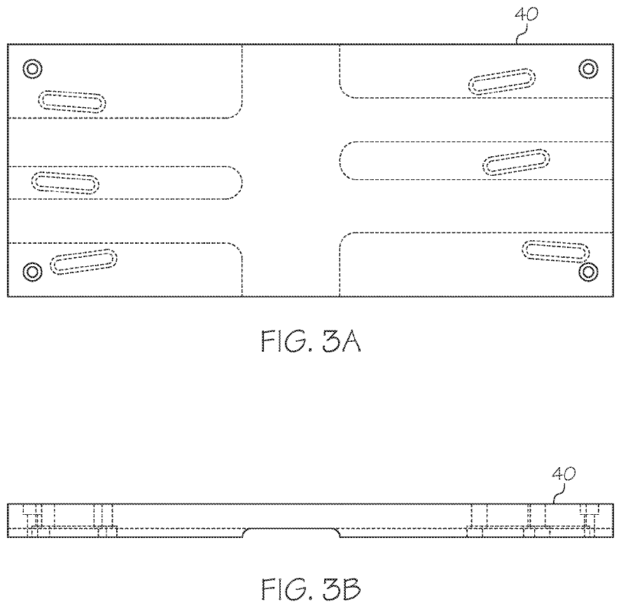

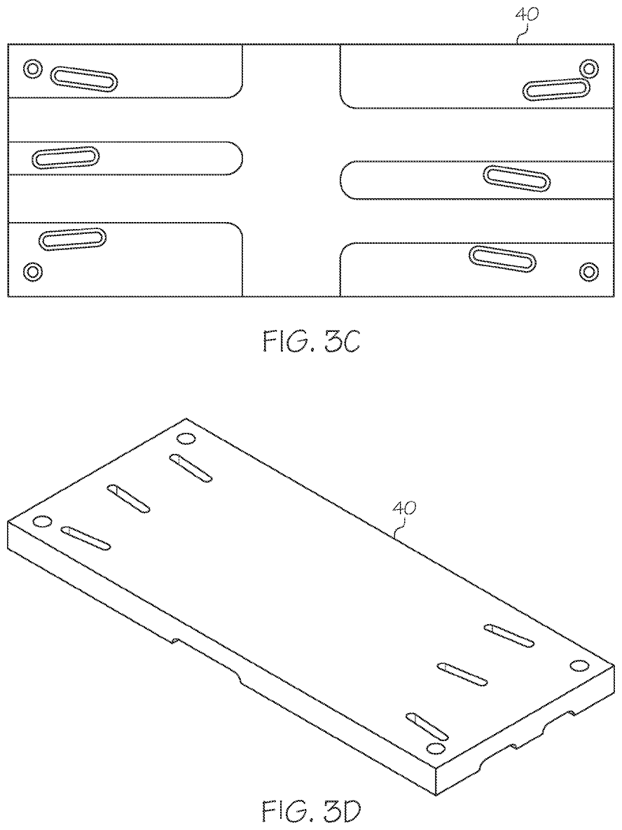

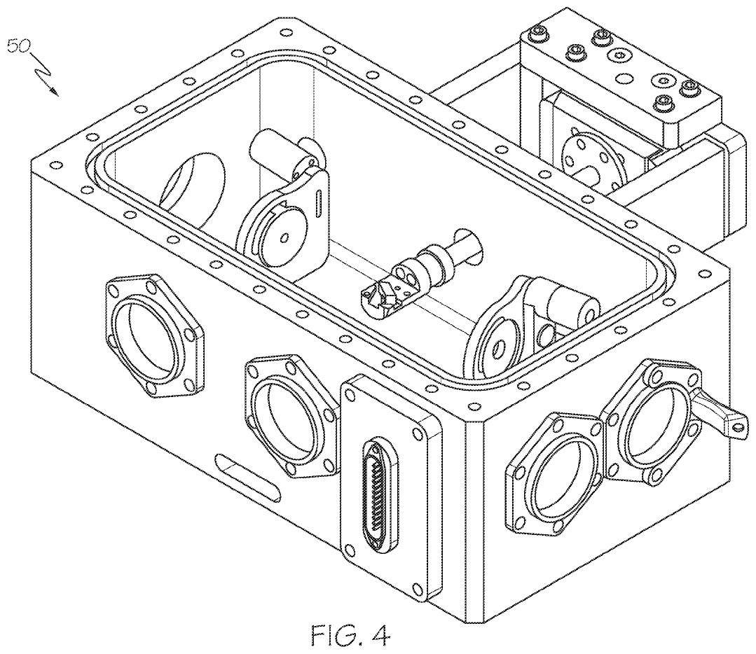

The modules of the present disclosure may be in various forms. For instance, in some embodiments, the modules of the present disclosure are in the form of a cavity, such as a ring cavity. In some embodiments, the modules of the present disclosure are made of aluminum. In some embodiments, the modules of the present disclosure are positioned on a detachable module, such as detachable plate 40 illustrated in FIG. 3A-3D.

### Laser Generation Systems

In some embodiments, the modules of the present disclosure are a component of a laser generation system. In some embodiments, the present disclosure pertains to laser generation systems that include the modules of the present disclosure.

The modules of the present disclosure may be associated with laser generation systems in various manners. For instance, in some embodiments, the modules of the present disclosure are detachable from the laser generation system through a detachable module, such as detachable plate 40 illustrated in FIGS. 3A-3D. In some embodiments, the detachable module may host cavity mirrors but not the optically non-linear material, which may be attached from a separate enclosure that provides the mounting positions. In some embodiments, such an arrangement will disconnect, at least to some extent, the thermal coupling between the cavity and the optically non-linear material, especially when the latter is heated or cooled to a temperature different from the cavity. In some embodiments, the optically non-linear material can also be installed on the detachable module.

The modules of the present disclosure may be associated with various types of laser generation systems. For instance, in some embodiments, the laser generation system includes a narrow-bandwidth continuous wave (cw) laser system.

### Methods of Generating a Laser

In some embodiments, the present disclosure also pertains to methods of generating a laser beam. In some embodiments, the methods of the present disclosure include passing a first laser beam and a second laser beam into a module of the present disclosure. In some embodiments, at least one of the first or second laser beams passes through the first aperture of the first mirror and into the module. In some embodiments, the optically non-linear material of the module performs sum frequency mixing of the two laser beams to generate the laser beam. In some embodiments, the generated laser beam exits out of the module through the second aperture of the second mirror.

The methods of the present disclosure can have various modes of operation. For instance, in some embodiments illustrated in FIG. 1, the methods of the present disclosure include passing a first laser beam 14 from laser source 13 and a second laser beam 16 from laser source 15 into module 10. Thereafter, first laser beam 14 passes through first aperture 26 of first mirror 22 and into module 10. The methods in this embodiment also include passing second laser beam 16 from laser source 15 onto mirror 32, which reflects laser beam 16 onto mirror 22, which subsequently reflects laser beam 16 onto optically non-linear material 12. Thereafter, optically non-linear material 12 performs sum frequency mixing of laser beams 14 and 16 to generate laser beam 18. Generated laser beam 18 then exits out of module 10 through second aperture 28 of second mirror 24. In some embodiments, generated laser beam 18 exits out of module 10 without interacting with any mirrors in the module. In some embodiments, such modes of operation significantly reduce the degradation caused by generated laser beams (e.g., UV or DUV laser beams) on cavity mirrors and/or their coatings because the generated laser beams (e.g., UV or DUV laser beams) do not directly hit the mirrors.

The methods of the present disclosure may utilize various types of modules of the present disclosure. As such, in some embodiments, the methods of the present disclosure also include a step of providing the modules of the present disclosure.

In some embodiments, the modules of the present disclosure are a component of a laser generation system of the present disclosure. As such, in some embodiments, the methods of the present disclosure also include a step of providing a laser generation system of the present disclosure.

### Applications and Advantages

The modules, laser generation systems and methods of the present disclosure can have numerous advantages. For instance, in some embodiments, the modules of the present disclosure are tunable for generating lasers of desired wavelengths. In some embodiments, the modules of the present disclosure are designed to enhance laser power to intensities of at least 1 W. In some embodiments, the modules of the present disclosure utilize components compatible for use in an ultrahigh vacuum (UHV) environment. Such exemplary applications are advantageous in some embodiments because UHV components are known to emit minimal amounts of unwanted impurity substances that may deposit on laser optics. In some embodiments, the modules of the present disclosure use preparation procedures standard for UHV components, such as baking at high temperatures while vacuum pumping the entire laser enclosure. As such, in some embodiments, the laser generation systems may have vacuum and gas entry ports available.

In some embodiments, the modules, laser generation systems and methods of the present disclosure provide a way to make a UV laser that is tunable in wavelengths from around 180 nm to 250 nm at high outputs of about 1 W. Moreover, the design of the modules of the present disclosure may be compact and modular, thereby offering flexibility to users. For instance, in some embodiments, users may choose or change critical parameters of a module, such as lengths, types and sizes of optically non-linear materials (e.g., nonlinear crystals) in order to generate a desired laser output.

Additionally, the modules of the present disclosure may provide a long lifetime, particularly due to low outgassing rates. Moreover, the modules of the present disclosure may be compatible for use in ultrahigh vacuum environments.

Furthermore, the modules of the present disclosure may include compact sizes. Such compact sizes may include sizes of approximately 260 mm×150 mm in outer size.

As such, the modules, laser generation systems and methods of the present disclosure can include numerous applications. For instance, in some embodiments, the modules, laser generation systems, and methods of the present disclosure may be utilized for ion or atom-based quantum technologies, where high-intensity laser is required to cool or manipulate atoms and ions, since each atomic species require different wavelengths of light. In some embodiments, the modules and laser generation systems of the present disclosure may also be utilized for semiconductor research, where UV light is frequently used to inspect patterned wafers. Moreover, due to their compact nature, the modules and laser generation systems of the present disclosure may enable applications that were only capable of being carried out in synchrotron facilities operated by national labs to be carried out in tabletop instruments.

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Development of an Angle-Resolved Photoelectron Spectroscopy System

This Example illustrates the development of an angle-resolved photoelectron spectroscopy (ARPES) system. In particular, Applicant built a laser system while purchasing other key components of the spectroscopy system from commercial sources. Applicant fabricated a continuous wave UV laser tunable in wavelength at around 192-195 nm, which is sufficiently short a wavelength to trigger photoemission processes in materials. Applicant's technique involves two-stage frequency conversion cavities, which use commercially available laser beams (532 nm & IR laser) as inputs. The first stage that uses 532 nm light as input successfully produced 266 nm light. The second cavity, which produces the 192 nm light with the input of the 266 nm light from the first stage and the IR light, is designed using computer-aided software (Autodesk Inventor) and assembled.

In the process of designing the second cavity, Applicant devised an idea that allows both the tunability in wavelength and potentially the enhancement of a laser power at deep UV wavelengths. Applicant's custom laser will be tunable in wavelength, which enables experiments normally only carried out in synchrotron facilities operated by national labs, in a tabletop instrument. Furthermore, Applicant's approach could enable much higher intensity (˜1 W) through further optimization.

In particular, Applicant constructed a frequency conversion cavity in which continuous wave (cw) deep UV laser beams with tunable wavelengths of around 192-195 nm can be generated. The laser beam generation is based on sum frequency generation (i.e., mixing of two laser beams) in a nonlinear crystal. The system consists of a ring (bow-tie) cavity in which holes, slits, or apertures created in at least one of the cavity mirrors enable efficient input and output of laser beams. The cavity is built in a vacuum tight box, capable of achieving high vacuum or ultra-high vacuum, made primarily of aluminum, which has an overall external size of about 150 mm×260 mm, as illustrated in FIG. 4.

The laser mirror is mounted on a detachable base made of low-heat-expansion material, which enables easy modification of mirror arrangement without re-manufacturing the outer vacuum box. The apertures in cavity mirrors are specifically designed to let the generated laser light pass through them without being blocked, even when a nonlinear crystal is rotated to tune the output wavelength (via tuning of “phase-matching angle”) that results in a change of laser path. The method is suitable to generate monochromatic laser light at around 192-205 nm or shorter, where an absorption of laser light in optics as well as in air reduces the final output laser power. The custom apertures (slit or holes) in the cavity mirrors improve the output efficiency and prevents the degradation of cavity mirrors with intense vacuum.

The system in this Example has at least three components. First, apertures in the laser cavity mirrors enable wide tunability in the output wavelengths of the continuous wave laser. An aperture in cavity mirrors has been used, for example, for the output of ultrafast pulsed lasers in the past. However, Applicant is unaware of any earlier works that applied this method for tunable cw lasers. Moreover, Applicant's design utilizes such apertures not only for output, which has been used in aforementioned ultrafast cavities, but also for the input of laser beams.

As second component of the system in this Example is the use of a detachable plate where the cavity is placed (cavity stage) (e.g., detachable module 40 illustrated in FIGS. 3A-3D). A monolithic design is often used for lasers, in which a laser box is milled from a single aluminum block and engraved custom slots is used to directly mount optics. Applicant's design also uses a monolithic aluminum box but makes the cavity stage detachable, which allows easy modifications of the cavity design. This is especially beneficial to accommodate a specific request of users. Furthermore, such a design may limit the impact of heat from crystal heaters directly impacting the cavity geometry, such as length of the cavity, because the crystal is not directly mounted on the detachable plate.

A third component of the system in this Example is the ability of the system to be readily upgraded into an ultrahigh vacuum (UHV) specification (e.g., environments with small residual gas pressures). Applicant's design in this Example already uses CF flanges for laser windows and feedthroughs suitable for UHV. The UHV environment, when adopted for alternative versions of laser cavities, may further improve the lifetime of the laser mirrors and nonlinear crystals, whose surfaces are known to degrade under intense laser light if there are residual organic impurities in the environment. As such, a complete UHV design could assist in producing ultimate laser power with the highest stability.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A module comprising:
an optically non-linear material operable to receive at least a first laser beam and a second laser beam and perform sum frequency mixing of the first and second laser beams to generate another laser beam;
a first mirror and a second mirror,
wherein the first mirror comprises a first aperture operable for passing at least one of the first or second laser beams through the first mirror and into the module, and
wherein the second mirror comprises a second aperture operable for passing the generated laser beam through the second mirror and out of the module.

2. The module of claim 1, wherein the first and second laser beams comprise different wavelengths.

3. The module of claim 1, wherein the first laser beam comprises a wavelength of at least 200 nm.

4. (canceled)

5. The module of claim 1, wherein the first laser beam comprises a wavelength of at least 500 nm.

6. (canceled)

7. The module of claim 1, wherein the second laser beam comprises a wavelength of at least 500 nm.

8. (canceled)

9. The module of claim 1, wherein the second laser beam comprises a wavelength ranging from 690 nm to 850 nm.

10. The module of claim 1, wherein the optically non-linear material comprises a non-linear crystal.

11. The module of claim 1, wherein the optically non-linear material comprises an optical fiber.

12. The module of claim 1, wherein the first mirror and second mirror are on opposite sides of the module.

13. The module of claim 1, wherein the first mirror and second mirror are detachable from the module.

14. The module of claim 1, wherein the first mirror and second mirror are adjustable.

15. The module of claim 1, wherein the first and second apertures each independently comprise at least one of holes, slits, openings, or combinations thereof.

16. The module of claim 1, wherein the first aperture of the first mirror is in the form of a continuous opening through the first mirror.

17. The module of claim 1, wherein the second aperture of the second mirror is in the form of a continuous opening through the second mirror.

18. The module of claim 1, wherein the first and second apertures each do not block the passage of the input or output laser beams.

19. The module of claim 1, wherein the generated laser beam is a monochromatic laser comprising a single wavelength.

20. The module of claim 1, wherein the generated laser beam comprises a wavelength ranging from 180 nm to 250 nm.

21. The module of claim 1, wherein the generated laser beam comprises an ultraviolet (UV) laser beam or a deep ultraviolet (DUV) laser beam.

22. (canceled)

23. (canceled)

24. (canceled)

25. The module of claim 1, wherein the module is suitable for use in an ultrahigh vacuum environment.

26. The module of claim 1, wherein the module is a component of a laser generation system, and wherein the module is detachable from the laser generation system.

27. (canceled)

28. (canceled)

29. The module of claim 26, wherein the laser generation system comprises a narrow-bandwidth continuous wave (cw) laser system.

30. (canceled)

31. A method of generating a laser beam, said method comprising:
passing a first laser beam and a second laser beam into a module, wherein the module comprises:
an optically non-linear material operable to receive at least a first laser beam and a second laser beam and perform sum frequency mixing of the first and second laser beams to generate another laser beam,
a first mirror and a second mirror, wherein the first mirror comprises a first aperture operable for passing at least one of the first or second laser beams through the first mirror and into the module, and wherein the second mirror comprises a second aperture operable for passing the generated laser beam through the second mirror and out of the module,
wherein at least one of the first or second laser beams passes through the first aperture of the first mirror and into the module,
wherein the optically non-linear material of the module performs sum frequency mixing of the at least two laser beams to generate the laser beam, and
wherein the generated laser beam exits out of the module through the second aperture of the second mirror.

32. The method of claim 31, further comprising a step of providing the module of claim 31.

33. The method of claim 31, wherein the module is a component of a laser generation system.

34. The method of claim 33, further comprising a step of providing the laser generation system.
